(19) United States
(12) Patent Application Publication
(10) Pub. No.: US 2019/0032371 A1
(43) Pub. Date: Jan. 31, 2019

(54) DISPOSABLE EMERGENCY DUTY LATCH DISABLING STRIP

(71) Applicants: Steven Koszis, Glendale, CA (US); Christopher Brewer, Valencia, CA (US)

(72) Inventors: Steven Koszis, Glendale, CA (US); Christopher Brewer, Valencia, CA (US)

(21) Appl. No.: 16/035,451

(22) Filed: Jul. 13, 2018

Related U.S. Application Data
(60) Provisional application No. 62/539,461, filed on Jul. 31, 2017.

(51) Int. Cl. E05B 63/18; E05C 17/54

(52) U.S. Cl. CPC E05B 63/185; E05C 17/54

(57) ABSTRACT

A Disposable Emergency Duty Latch Disabling Strip having length and elasticity enough to fit around almost any door jamb security mechanism is made of a thin, tough elastomer. A first handle-adaptive hole fits around a door knob, handle or lever on one side of the door. A latch-enveloping middle portion of the Strip has width and puncture strength enough to cover a door's latch-bolt and strike plate or other latching portion and restrain any spring-bolts or latches from engaging. The remaining handle-adaptive end portion of the Strip wraps around to the far side of the door and is attached to the far side door mechanisms using the remaining handle-adaptive hole. Depending on door tolerances, the door will either wedge open or the lock will be prevented from engaging. The Strip resists heat, cold, shearing, abrasion and can be folded to deploy from a dispenser, belt or pocket.

### CROSS-REFERENCE TO RELATED APPLICATION

This application claims priority under 35 U.S.C. § 119(e) from U.S. Provisional Patent Application No. 62/539,461, entitled “DISPOSABLE EMERGENCY DUTY LATCH DISABLING STRIP”, filed 31 Jul. 2017, which is incorporated by reference for all purposes.

### FIELD OF THE INVENTION

The invention disclosure relates a flexible, disposable piece of emergency duty personnel kit deployable to reliably disable locks and latches on doors and gates in dangerous conditions.

### BACKGROUND

First responders, including law enforcement officers, parole officers, probation officers, firefighters, paramedics, EMTs and EMS workers frequently encounter an unknown locking or lockable gate or door. To secure their own exit, and to assure that other first responders can follow, they often have to search, in the dark and in a hurry, to find something to block the door open and prevent any locking mechanisms on the door from engaging. Actual common improvised door blocking mechanisms include jamming wadded up paper into the strike plate hole, stuffing a business card into the lock, strips of duct tape pre-disposed on a flashlight handle, or hoping to find a trash can, a rug, or a brick to simply prop the door open.

Improvised door-blocking mechanisms take away critical time needed to render aid on any emergency call. They are too often removed by passers-by, fail due to environmental conditions or simply fall out of place unnoticed when the next officer opens the door.

What is needed is a first responder's tool for quickly disabling all sorts of door and gate locking mechanisms and preventing doors and gates from closing behind them. Because first responders are already burdened with tools, it should be light, fit in almost any pocket and be deployable in seconds. It must be weatherproof and chemical resistant. It should be tough, reliable and reusable but also, ideally, economical and disposable, since such a tool will often get left behind during emergencies.

### SUMMARY OF THE INVENTION

A Disposable Emergency Duty Latch Disabling Strip having, in combination, length and elasticity enough to fit around almost any door jamb security mechanism is made of a thin, tough elastomer. A first rounded end portion with a handle-adaptive hole fits around a door knob, handle or lever on one side of the door. A latch-enveloping middle portion of the Disposable Emergency Duty Latch Disabling Strip has, in combination, width and puncture strength enough to cover a door's latch-bolt and strike plate or other latching portion and restrain any spring-bolts or latches from engaging. The remaining handle-adaptive end portion of the Strip wraps around to the far side of the lockable door and is attached to the far side door mechanisms using the remaining handle-adaptive hole. Depending on door tolerances, the door will either wedge open or the lock will be prevented from engaging. The Disposable Emergency Duty Latch Disabling Strip is thin, flexible and can be folded or rolled to deploy from a pocket, belt pouch, clasp or dispenser.

### BRIEF DESCRIPTION OF THE DRAWINGS

FIG. 1 (PRIOR ART) shows a bulky door-knob hanger device intended for propping a door partially open under non-emergency conditions.

FIG. 2 is an unfolded view of the Disposable Emergency Duty Latch Disabling Strip showing the latch-enveloping middle portion between the two handle-adaptive end portions according to the preferred embodiment.

FIG. 3 is a perspective view of the Disposable Emergency Duty Latch Disabling Strip showing the device flexed and folding under its own weight such that the side-on edge is apparent.

FIG. 4 is an illustration of the Emergency Duty Latch Disabling Strip deployed so as to disable the latching of an old-fashioned overlapping pair of doors

FIG. 5 is an illustration of the Emergency Duty Latch Disabling Strip deployed against a modern industrial-grade door with lever handles and an off-center spring-bolt.

### DETAILED DESCRIPTION

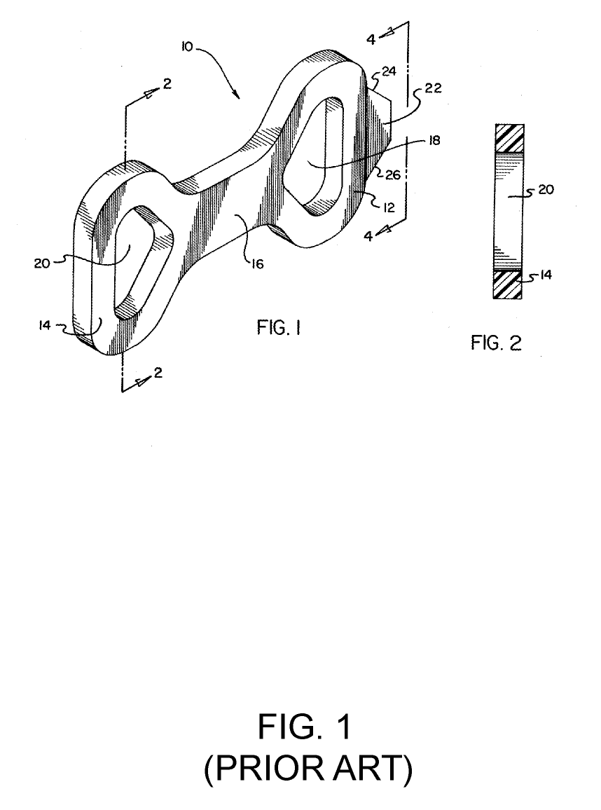

FIG. 1(PRIOR ART) shows a bulky door-knob hanger device intended for propping a door partially open under non-emergency conditions in the prior art at U.S. Pat. No. 5,291,631. A flexible, rubber-like member in the shape of a flat “dumbbell” has a pair of holes at either enlarged end thereof for fitment respectively about the opposed knobs or handles of a door with the narrow portion thereof wrapping around the side edge of the door proximal the knobs to prevent closure of the door.

The thick rubber of the device of FIG. 1 is rigid enough to hold a shape with triangular holes and such that the middle portion is narrower than the two end portions. The narrow middle portion is neither wide enough to reliable cover a strike-plate hole nor flexible enough to wrap around and cover a spring-bolt. Instead, the device of FIG. 1 simply wedges a door open with its thick bulk. The thickness of the material is required to allow the implanting of signaling mechanisms, and the large, rigid door knob holes are designed for the doors of a children's nursery. The device, overall, is too large and rigid to be disposable or portable as part of emergency equipment or deployable in numbers. Nor is it adaptable to many door configurations.

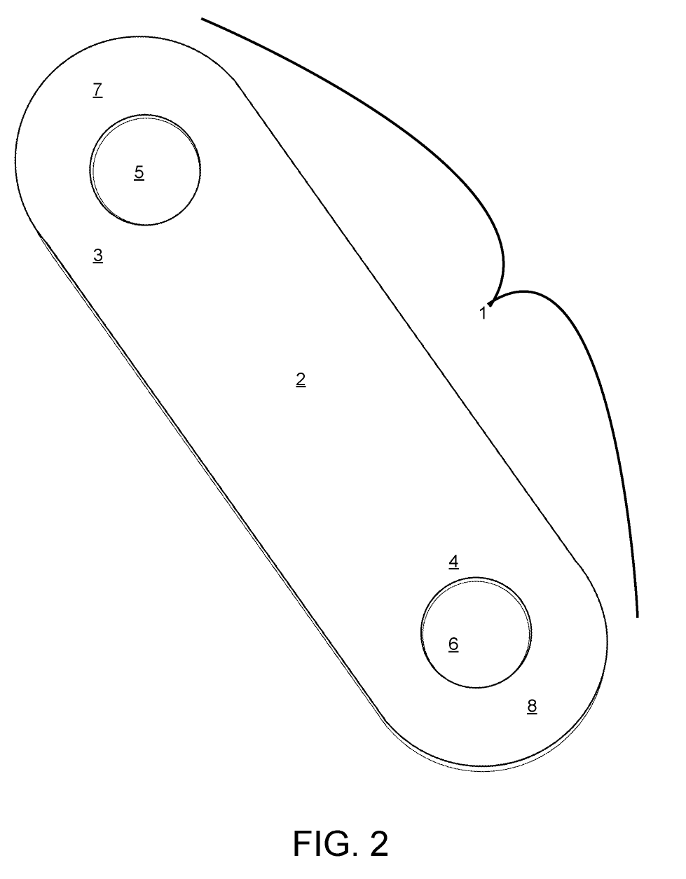

FIG. 2 is an unfolded view of the Disposable Emergency Duty Latch Disabling Strip 1 showing the latch-enveloping middle portion 2 between the first 3 and second 4 handle-adaptive end portions according to the preferred embodiment. For ease and economy of manufacturing, the Disposable Emergency Duty Latch Disabling Strip can be manufactured by die-cutting: a sheet or strip of elastic material is cut to produce the sought shape of a particular elongated strip with handle-adaptive holes 5 and 6 for accommodating door mechanisms at either end. Alternatively, the device of the invention can be manufactured by solidifying in a mold of the sought shape. In the preferred embodiment, the sought strip has a lozenge, or rounded rectangle, shape, with a radius or semi-circular surrounding portion at each end 7 and 8 surrounding each handle-adaptive hole. The lozenge shaped strip is not made with shape corners in the preferred embodiment, as corner material would contribute extra bulk without contributing material strength.

The elastic material used in the Disposable Emergency Duty Latch Disabling Strip can be any elastomer capable of being manufactured to the specifications in this disclosure and used to prevent a door from locking according to the methods described in this disclosure.

Elastomers that are possible include solid neoprene, natural gum rubber, silicone and latex. The elastomer type is not critical to the product, so long as it falls within most or all of the specifications.

Gum rubber and solid neoprene, in particular, have been found to be manufacturable both to meet the specifications of this disclosure and for economy. Natural gum rubber can suffice for police applications, for example, since it withstands temperate ranges between 212 F to −20 F and can be manufactured inexpensively.

For firefighter applications, an elastic silicone strip can be preferable. Molding and curing of silicone can be more expensive than gum rubber, and silicone can have poorer elastic properties at moderate temperatures than gum rubber, necessitating more material. However, at extreme temperatures, silicone rubber is more durable than gum rubber. Typical silicone rubbers can function to arrest door latches in this application at temperatures as high as 572 degrees Fahrenheit and as low as −178 degrees Fahrenheit.

Some silicone rubber gasket materials can intermittently stand temperatures up to 650 Fahrenheit. Other silicone rubbers specially formulated for extreme temperatures, such as Resbond Fireproof, can survive up 2350 degrees Fahrenheit. This application contemplates use of such high temperature elastomers in cases where they also exhibit sufficient tensile strength to resist tearing and sufficient hardness at ⅛ inch thickness to arrest a fifteen-pound spring-bolt.

In terms of tensile strength, even the weaker silicones such as Room Temperature Vulcanize exhibit strength of 800 psi or more and can be made to have elasticity of up to 370%. Others, such as Fluorosilicone Rubber and High Consistency Rubber, can have much higher tensile strength and elasticity.

By matter of contrast, foam or closed-cell neoprene has not been found to be usable in the door-latch disabling application of the Strip because it lacks the tear strength or puncture resistance to reliably impede spring-bolts. Similarly, an elasticized cloth material such as Spandex would likely be usable only if it is a latch-adaptive elasticized cloth material made thick enough to arrest a latch-bolt and to wedge a doorjamb, and if it is not used for firefighter applications where the cloth matrix would catch fire.

And, a non-elastic material is not workable in this application due to the versatility of door locks, gate locks, window locks and security device configurations encountered by emergency personnel.

It is noted that the latch-enveloping middle portion is at least as wide as the two handle-adaptive end portions. In the preferred embodiment, the Disposable Emergency Duty Latch Disabling Strip has a width of three inches. The three inch width allows the latch-enveloping middle portion to cover and restrain the latch-bolt of various configurations found in gates and doors in commercial, industrial and residential applications where a latch-bolt might be offset from the doorknobs or levers. A 20% width variance in either direction is functional but not preferred, so the latch-enveloping middle portion can be from 2.4 to 3.6 inches wide.

Note that an alternate embodiment can give the latch-enveloping middle portion greater latch-engaging width by cutting the Strip in an oval shape, with the latch-enveloping middle portion increasing to a middle width greater than the two handle-adaptive end portion widths.

In the preferred embodiment, the Strip has a ten inch length at rest-when not being stretched. This, along with the elasticity, allows it to wrap around most door edges, handles, locking mechanisms, keypads and any other installed security devices or features of the door. A 20% length variance in either direction is functional but not preferred, so the Strip can be from 8 to 12 inches in length.

Also in the preferred embodiment, the handle-adaptive end portions have handle-adaptive through-holes one and one quarter inch, or five-quarter inches, in diameter. This size handle-adaptive hole, combined with the elongation properties of the elastomer, allows for the handle-adaptive end portions to be stretched and slipped over most knobs, handles, levers and other mechanisms used to open doors. A 20% diameter variance in either direction is functional but not preferred, so the handle-adaptive holes may be between one and one-and-one-half inch. The handle-adaptive through-holes have an edge of elastomeric material which may also be called a perimeter.

In the case of through-holes that are not circular, at least one perimeter edge or diagonal should be between one and one & one-half inch. Further, the handle-adaptive holes allow for the Strip to be wrapped through itself when tied around a door handle without a knob or lever, and secured when otherwise adapted to unusual door configurations. Here, a standard door handle may be defined as any of a knob, handle, lever, door-pull, U-bar, push-bar, extruded lock, combination lock panel, or other commonly manufactured door opening, locking or pulling mechanism and capable of having a strip of elastic material tied, wrapped or adhered to it.

Due to manufacturing variances, and because the Strip is elastic, some variation in width of the latch-enveloping middle portion, length of the Strip, size of the handle-adaptive through-holes, and in other measurements is possible. However, because the Strip must resist breaking, abrading and tearing in cold, in heat, in emergency situations and with a wide range of door configurations, dimensions and tolerances of less than eighty percent those described in regard to the preferred embodiment can not be considered reliable.

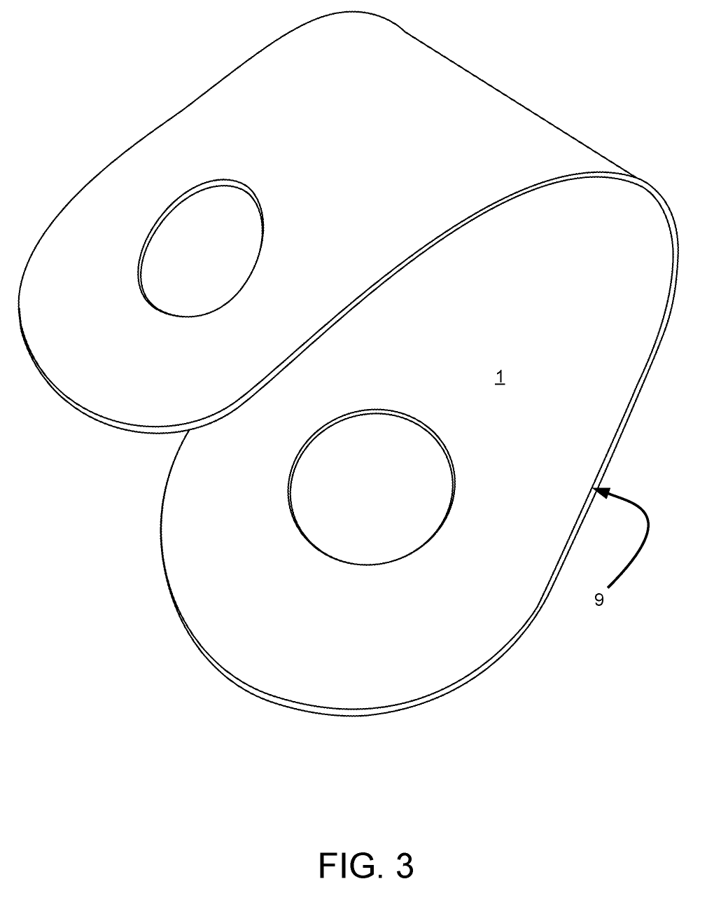

FIG. 3 is a perspective view of the Disposable Emergency Duty Latch Disabling Strip 1 showing the preferred embodiment flexed and folding under its own weight such that the side-on edge 9 is apparent. The side-on edge thickness can be one-sixteenth inch to one-eighth inch ( 1/16″-⅛″), depending on material. This thickness is used because it can physically prevent a door from closing by wedging between the door and doorjamb. It is also thick enough to wedge some doors with close tolerances. However, the Strip is also thin enough to carry discreetly in pockets whether rolled or folded. And, in combination with the chosen elastomer material, testing shows that materials within this range of thicknesses ensures the latch-enveloping middle portion has the puncture-resistance and deformation-resistance to restrain spring-bolts and other latch-bolts.

The elastomer of the Strip in the preferred embodiment is capable of a minimum elongation (tip to tip) of three times or three-hundred percent (300%). This elongation property is important so that the Strip has a compact form in its relaxed state to carry discreetly in a compact storage compartment. A 20% elasticity variance is functional but not preferred, so the Strip elastomer material must have an elasticity of at least 240%. Thus, the stretch length in a Strip having a 10 inch rest length and 300% elasticity of the preferred embodiment will be 30 inches. The stretch length in an alternate embodiment Strip having an 8 inch rest length and 240% elasticity will be 19.2 inches. Different sizes and elongations may be manufactured for regions with different building practices.

It is also preferred that the elongation property be under 360%, in order to retain deformation resistance. Elongation also allows the Strip to relax short or stretch long, thus giving the range of differences in reach needed to wrap around numerous types of doors and gates with or without security features that increase the effective distance from one side of the door to the other. In contrast, a Strip of strong, flexible plastic without the ability to elongate would need to be approximately thirty inches in length to wrap around the effective distances from one side of a door to the other. Such a long Strip would need to be laboriously wrapped and knotted for shorter effective distances, and would be subject to tangling, making for a less desirable embodiment of the invention.

The material of the Strip at its given thickness must be capable of resisting tearing as it elongates. Thus, the Strip should have a tensile strength of seven hundred pounds per square inch (700 PSI) in the preferred embodiment. This strength is important so a user will not inadvertently tear the product by applying too much pressure using human force alone. A 20% variance in tensile strength is functional but not preferred, so a minimum tensile strength of 560 pounds per square inch (560 PSI). A stretch strength of at least 560 PSI allows the product to withstand most stresses and door configurations.

Finally, the partially bent shape of the Strip in FIG. 3 illustrates the hardness of the invention. The invention folds under its own weight, but does not so fold completely flat. Instead, the Disposable Emergency-Duty Latch-Disabling Strip naturally maintains is original shape and returns to a flat position. The Strip of the invention is hard enough to withstand punctures by latch-bolts or the pressure of doors slammed closed on it. However, the invention of the disclosure must also be soft enough to remain flexible for storage in compact pockets, but flexible enough to allow twisting without compromising integrity or tearing.

Testing has shown that the invention must, therefore, be made of elastic material with a durometer of at least 36, and at most 54, according to the Shore A hardness test. In the preferred embodiment, the Emergency Duty Latch Disabling Strip has a durometer of 45, with an allowable variation of plus or minus 20% according to the Shore A hardness test (45 Shore A, +/−5). This degree of hardness allows the Strip to successfully restrain a 15-pound spring-bolt, which is the maximum spring-bolt force typically used in light of disability concerns.

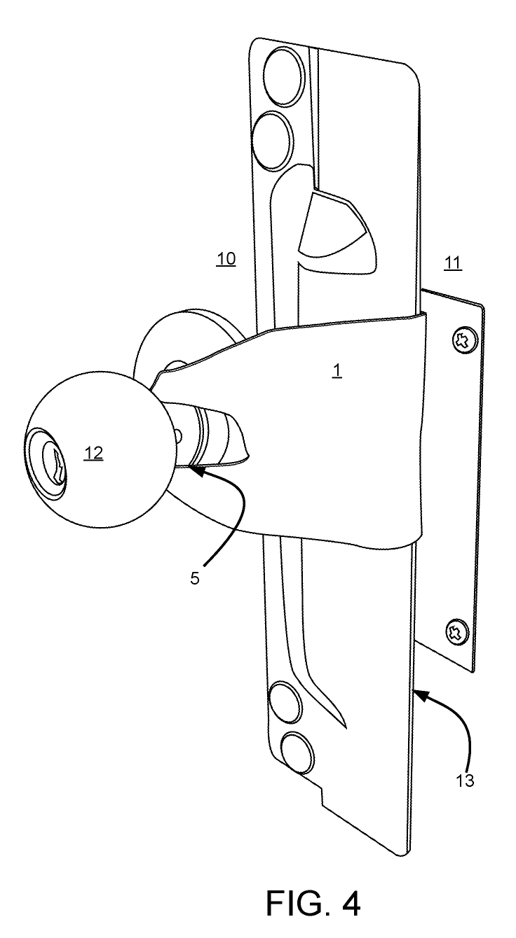

FIG. 4 is an illustration of the Emergency Duty Latch Disabling Strip deployed so as to disable the latching of an old-fashioned overlapping pair of doors 10 and 11. The illustration accompanies a description of methods of using the invention. Here, arresting the latch is defined to be disabling the locking operation of a door as follows: The Strip material restrains the spring-bolt or dead-bolt partially or entirely inside the bolt-hole such that it does not engage its locking mechanism or such that it does not engage the door jamb or strike plate sufficiently to lock the door. Alternatively, arresting the latch is accomplished when the Strip material restrains the door edge from fitting into the door jamb, holding it open.

For the purpose of claiming the invention, an adjacent door edge may be defined as the long edge of a door opposite the hinged edge and containing the locking mechanism allowing a locking bolt to interface with a strike-plate when the door is shut and the adjacent door edge is flush with the door jamb. Such adjacent edge will therefore also typically be adjacent any standard door handle.

As noted above, the Strip is flexible and foldable. Thus, a first-responder or other user can add the Strip to his equipment by folding or rolling one or more Emergency Duty Latch Disabling Strips into a compact shape and fitting them into a pocket or belt pouch. One or more Strips can also be hooked onto a belt, buckle, snap, clasp or hook through the handle-adaptive holes of the end portions, or even temporarily tied around a belt, belt loop or even an arm by pulling one end through the handle-adaptive hole of the opposite end. In some cases, multiple Strips will be packaged pre-folded in a box or dispenser that can be carried in a vehicle, backpack or large pocket.

When the user encounters a lockable door that he intends to prevent from becoming locked, so as to maintain entry during emergency situations, the Strip is quickly deployed with the primary goal of preventing spring-bolt or dead-bolt locks in the door from engaging. The user fits one of the handle-adaptive holes around one door knob, handle or lever, just as a handle-adaptive hole 5 is shown fitted around the round door-knob 12 of FIG. 4. The user then wraps the Strip 1 around the adjacent edge 13 of the door 10, making sure that the latch-enveloping middle portion 2 covers the latch-bolt.

If a spring-bolt is present, the latch-enveloping middle portion can undergo some deformation; the user checks that the latch-enveloping middle portion is effectively restraining the spring-bolt from locking the door. The user fits the remaining handle-adaptive hole around the knob, lever or other appropriate feature on the other side of the door, stretching the Strip if necessary.

If the Strip is, at this point, loose or hanging or the user simply wants to tighten the Strip to discourage removal, he can wrap, wind, twist or knot one handle-adaptive end portion around a door knob or lever before fitting the handle-adaptive hole over the knob. Alternatively, he can wrap one handle-adaptive end portion around the knob before tightening by pulling the other end portion back through its handle-adaptive hole.

In the same manner, door handles such as push-bars, door-pulls, U-bars, large keypads and others that cannot be dealt with by fitting a handle-adaptive through-hole over an extrusion can, instead, be handle by tying. The user loops a first end portion of the flat elastomer strip around such a door handle and then pulls the other end portion through the through-hole of the first end portion, making a closed loop around the handle.

Note that the overlapping type of double-door depicted in FIG. 4 can be held unlocked while appearing nearly closed using the thin Strip of the invention. In some cases, this will be a help to emergency personnel who wish to avoid drawing bypasser attention to the disabled door lock. The Emergency Duty Latch Disabling Strip of the invention can be manufactured in low-noticeability colors Steel Gray, Desert Tan, Tactical Black, and transparent or translucent colors.

Other users may prefer the Emergency Duty Latch Disabling Strip to have bright high-visibility coloring to alert other emergency responders, or even printed patterns or warnings to dissuade bypassers. Particular colors or markings of the Strip can even be matched to particular users or agencies to indicate to follow-on responders who the Strip was placed by.

One embodiment of the Strip specialized for use by firefighters incorporates a photoluminescent additive to the elastomer which makes the Strip produce a visible glow in hot, smoke-filled buildings. This aids a firefighter in visually locating the door through which he entered, and support personnel in following his path.

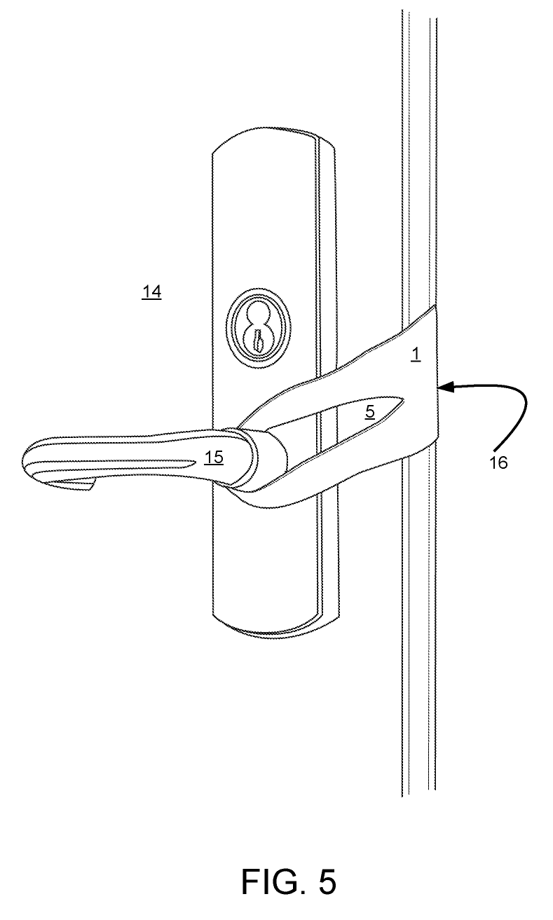

FIG. 5 is an illustration of the Emergency Duty Latch Disabling Strip 1 deployed against a modern industrial-grade door 14 with a lever handle 15 and an off-center spring-bolt area 16. The handle-adaptive through-hole 5 of one end portion 3 stretches to a slot-shape fittable to the depicted lever-shaped handle. The depicted off-center spring-bolt latch location 16 is above and to the side of the lever handle 15, rather than directly to the side of the lever handle.

A device middle portion width matching the diameter of the spring-bolt latch would slip from and fail to arrest an off-center latch mechanism of the type depicted. Instead, the latch-enveloping middle portion of the invention, being at least as wide as the two handle-adaptive end portions, easily spans the vertical difference between the latch mechanism and door handles, entirely covers the latch-bolt hole, restrains the latch bolt elastically, and leaves unstretched portions of elastomer extending around the edges of the latch bolt wedgable into the strike plate.

The remaining handle-adaptive end portion of the Strip wraps around to the far side of the depicted door and is attached to the far side door mechanisms using the remaining handle-adaptive hole according to one of the methods described above. Because of the design of the latch-enveloping middle portion of the Strip, the far side door mechanisms can also be vertically off-center, upward or downward, from the latch-bolt mechanism with no degradation in latch-arresting performance by the invention.

Because the invention is often deployed in rugged outdoor environments, direct sunlight, industrial facilities, warehouses and chemical storage, or during structure fire emergencies, the surface temperature of doors and door hardware can reach high temperatures. Therefore, Emergency Duty Latch Disabling Strip uses elastomer materials rated to withstand heat up to two-hundred and twelve degrees Fahrenheit (212 F). It must also be able to withstand cold as low as negative 20 degrees Fahrenheit (−20 F) without becoming brittle or breaking in use.

In an alternate embodiment, the Emergency Duty Latch Disabling Strip is made in a one-use format. The Strip is disposed with a one-use adhesive portion protected by a sticker backing or plastic baggy. The adhesive portion adheres the Strip to itself or to the door, making removal difficult without tearing. This one-use format can be used in areas where passers-by have a tendency to remove or reuse the Strips, or to aid in preserving the chain of events for later evidentiary reporting. For evidentiary purpose, an alternate embodiment may also be pre-markable with identifying information.

Although the present invention has been described in connection with certain specific embodiments for instructional purposes, the present invention is not limited thereto. Accordingly, various modifications, adaptations, and combinations of various features of the described embodiments can be practiced without departing from the scope of the invention.

What is claimed is:

1. A disposable emergency duty latch arresting strip, comprising:
a flat elastomer strip having a rest length, a stretch length, a rest width and a thickness,
said rest length being greater than said rest width and said rest width being greater than said thickness,
said stretch length being the greatest length to which the flat elastomer strip can be stretched lengthwise before breaking,
said flat elastomer strip having a lengthwise elasticity, said lengthwise elasticity being defined as the ratio of the flat elastomer strip's stretch length to its rest length at room temperature,
said flat elastomer strip comprising:
a first handle-adaptive end portion being an end of the flat elastomer strip,
a second handle-adaptive end portion being an end of the flat elastomer strip opposite the first handle-adaptive end portion,
a latch-enveloping middle portion disposed between the first handle-adaptive end portion and second handle-adaptive end portion,
said first handle-adaptive end portion having a first handle-adaptive through-hole with a perimeter;
said second handle-adaptive end portion having a second handle-adaptive through-hole with a perimeter;
said latch-enveloping middle portion having sufficient shear strength, sufficient puncture resistance and sufficient deformation resistance to arrest a standard door-latching spring-bolt;
the flat elastomer strip having a combination of rest length and lengthwise elasticity sufficient for the flat elastomer strip to span
from a first standard door-handle disposed on a front side of a door and adjacent a side edge of the door,
around the adjacent door side edge and
to a second standard door-handle, said second standard door-handle being disposed on a rear side of the door and adjacent said side edge of the door.

2. The disposable emergency duty latch arresting strip of claim 1,
the flat elastomer strip rest length being at least 8 inches and at most 12 inches; and,
the lengthwise elasticity being at least 240%.

3. The disposable emergency duty latch arresting strip of claim 1,
the first handle-adaptive end portion having a first end portion width;
the second handle-adaptive end portion having a second end portion width;
a latch-enveloping middle portion having a middle portion width,
the middle portion width being equal to or greater than the first end portion width; and,
the middle portion width being at least 2.4 inches and at most 3.6 inches.

4. The disposable emergency duty latch arresting strip of claim 1,
the flat elastomer strip having a durometer, the durometer being at least 36 and at most 54.

5. The disposable emergency duty latch arresting strip of claim 1,
the flat elastomer strip thickness being at least one-sixteenth inch and being at most one-eighth inch.

6. The disposable emergency duty latch arresting strip of claim 1,
the flat elastomer strip being capable of withstanding temperatures at least as high as two-hundred twelve degrees Fahrenheit (212 F);
the flat elastomer strip being capable of withstanding temperatures at least as cold as negative twenty degrees Fahrenheit (−20 F) without becoming brittle or breaking.

7. The disposable emergency duty latch arresting strip of claim 1,
The first handle-adaptive through-hole perimeter having a rest opening measurement when the first handle-adaptive through-hole is not at stretch,
said rest opening measurement being one of:
a diameter of the first handle-adaptive through-hole perimeter;
an edge length of the first handle-adaptive through-hole perimeter; or,
a diagonal length of the first handle-adaptive through-hole perimeter;
said rest opening measurement being at least one inch (1 in) and at most one and one-half inch (1.5 in).

8. The disposable emergency duty latch arresting strip of claim 1,
the flat elastomer strip having a tensile strength of at least 560 pounds per square inch (560 psi).

9. The disposable emergency duty latch arresting strip of claim 1,
the latch-enveloping middle portion having sufficient shear strength, sufficient puncture resistance and sufficient deformation resistance to prevent a fifteen pound spring latch from engaging a door jamb so as to lock a door.

10. The disposable emergency duty latch arresting strip of claim 1,
the first handle-adaptive end portion having a shape characterizable as one of:
a rectangle end having square corners, an end edge and two side edges;
a rectangle end having rounded corners, an end edge and two side edges;
an ovular end having a rounded point and two rounded side edges;
a lozenge end having a rounded tip and two side edges;
the first handle-adaptive hole having a continuous edge, the first handle-adaptive hole being equidistant the two side edges of the first handle-adaptive end portion.

11. The disposable emergency duty latch arresting strip of claim 1,
the flat elastomer strip rest length being at least 8 inches and at most 12 inches;
the lengthwise elasticity being at least 240%;
the first handle-adaptive end portion having a first end portion width;
the second handle-adaptive end portion having a second end portion width;
a latch-enveloping middle portion having a middle portion width,
the middle portion width being equal to or greater than the first end portion width; and,
the middle portion width being at least 2.4 inches and at most 3.6 inches.

12. The disposable emergency duty latch arresting strip of claim 1,
the flat elastomer strip rest length being at least 8 inches and at most 12 inches;
the lengthwise elasticity being at least 240%;
the first handle-adaptive end portion having a first end portion width;
the second handle-adaptive end portion having a second end portion width;
a latch-enveloping middle portion having a middle portion width,
the middle portion width being equal to or greater than the first end portion width;
the middle portion width being at least 2.4 inches and at most 3.6 inches; and,
the flat elastomer strip having a durometer, the durometer being at least 36.

13. The disposable emergency duty latch arresting strip of claim 1,
the flat elastomer strip rest length being at least 8 inches and at most 12 inches;
the lengthwise elasticity being at least 240%;
the first handle-adaptive end portion having a first end portion width;
the second handle-adaptive end portion having a second end portion width;
a latch-enveloping middle portion having a middle portion width,
the middle portion width being equal to or greater than the first end portion width;
the middle portion width being at least 2.4 inches and at most 3.6 inches;
the flat elastomer strip having a durometer, the durometer being at least 36; and,
the flat elastomer strip thickness being at least one-sixteenth inch and being at most one-eighth inch.

14. The disposable emergency duty latch arresting strip of claim 1,
the flat elastomer strip rest length being at least 8 inches and at most 12 inches;
the lengthwise elasticity being at least 240%;
the first handle-adaptive end portion having a first end portion width;
the second handle-adaptive end portion having a second end portion width;
a latch-enveloping middle portion having a middle portion width,
the middle portion width being equal to or greater than the first end portion width;
the middle portion width being at least 2.4 inches and at most 3.6 inches;
the flat elastomer strip having a durometer, the durometer being at least 36;
the flat elastomer strip thickness being at least one-sixteenth inch and being at most one-eighth inch;
the flat elastomer strip being capable of withstanding temperatures at least as high as two-hundred twelve degrees Fahrenheit (212 F);
the flat elastomer strip being capable of withstanding temperatures at least as cold as negative twenty degrees Fahrenheit (−20 F) without becoming brittle or breaking.

15. The disposable emergency duty latch arresting strip of claim 1,
the flat elastomer strip rest length being at least 8 inches and at most 12 inches;
the lengthwise elasticity being at least 240%;
the first handle-adaptive end portion having a first end portion width;
the second handle-adaptive end portion having a second end portion width;
a latch-enveloping middle portion having a middle portion width,
the middle portion width being equal to or greater than the first end portion width;
the middle portion width being at least 2.4 inches and at most 3.6 inches;
the flat elastomer strip having a durometer, the durometer being at least 36;
the flat elastomer strip thickness being at least one-sixteenth inch and being at most one-eighth inch;
the flat elastomer strip being capable of withstanding temperatures at least as high as two-hundred twelve degrees Fahrenheit (212 F);
the flat elastomer strip being capable of withstanding temperatures at least as cold as negative twenty degrees Fahrenheit (−20 F) without becoming brittle or breaking;
the first handle-adaptive through-hole perimeter having a rest opening measurement when the first handle-adaptive through-hole is not at stretch,
said rest opening measurement being one of:
a diameter of the first handle-adaptive through-hole perimeter;
an edge length of the first handle-adaptive through-hole perimeter; or,
a diagonal length of the first handle-adaptive through-hole perimeter; and,
said rest opening measurement being at least one inch (1 in) and at most one and one-half inch (1.5 in).

16. The disposable emergency duty latch arresting strip of claim 1,
the flat elastomer strip rest length being at least 8 inches and at most 12 inches;
the lengthwise elasticity being at least 240%;
the first handle-adaptive end portion having a first end portion width;
the second handle-adaptive end portion having a second end portion width;
a latch-enveloping middle portion having a middle portion width,
the middle portion width being equal to or greater than the first end portion width;
the middle portion width being at least 2.4 inches and at most 3.6 inches;
the flat elastomer strip having a durometer, the durometer being at least 36;
the flat elastomer strip thickness being at least one-sixteenth inch and being at most one-eighth inch;
the flat elastomer strip being capable of withstanding temperatures at least as high as two-hundred twelve degrees Fahrenheit (212 F);
the flat elastomer strip being capable of withstanding temperatures at least as cold as negative twenty degrees Fahrenheit (−20 F) without becoming brittle or breaking;
the first handle-adaptive through-hole perimeter having a rest opening measurement when the first handle-adaptive through-hole is not at stretch,
said rest opening measurement being one of:
a diameter of the first handle-adaptive through-hole perimeter;
an edge length of the first handle-adaptive through-hole perimeter; or,
a diagonal length of the first handle-adaptive through-hole perimeter;
said rest opening measurement being at least one inch (1 in) and at most one and one-half inch (1.5 in); and,
the flat elastomer strip having a tensile strength of at least 560 pounds per square inch (560 psi).

17. The disposable emergency duty latch arresting strip of claim 1,
the flat elastomer strip rest length being at least 8 inches and at most 12 inches;
the lengthwise elasticity being at least 240%;
the first handle-adaptive end portion having a first end portion width;
the second handle-adaptive end portion having a second end portion width;
a latch-enveloping middle portion having a middle portion width,
the middle portion width being equal to or greater than the first end portion width;
the middle portion width being at least 2.4 inches and at most 3.6 inches;
the flat elastomer strip having a durometer, the durometer being at least 36;
the flat elastomer strip thickness being at least one-sixteenth inch and being at most one-eighth inch;
the flat elastomer strip being capable of withstanding temperatures at least as high as two-hundred twelve degrees Fahrenheit (212 F);
the flat elastomer strip being capable of withstanding temperatures at least as cold as negative twenty degrees Fahrenheit (−20 F) without becoming brittle or breaking;
the first handle-adaptive through-hole perimeter having a rest opening measurement when the first handle-adaptive through-hole is not at stretch,
said rest opening measurement being one of:
a diameter of the first handle-adaptive through-hole perimeter;
an edge length of the first handle-adaptive through-hole perimeter; or,
a diagonal length of the first handle-adaptive through-hole perimeter;
said rest opening measurement being at least one inch (1 in) and at most one and one-half inch (1.5 in);
the flat elastomer strip having a tensile strength of at least 560 pounds per square inch (560 psi); and,
the latch-enveloping middle portion having sufficient having sufficient shear strength, sufficient puncture resistance and sufficient deformation resistance to prevent a fifteen pound spring latch from engaging a door jamb so as to lock a door.

18. The disposable emergency duty latch arresting strip of claim 1,
the flat elastomer strip rest length being at least 8 inches and at most 12 inches;
the lengthwise elasticity being at least 240%;
the first handle-adaptive end portion having a first end portion width;
the second handle-adaptive end portion having a second end portion width;
a latch-enveloping middle portion having a middle portion width,
the middle portion width being equal to or greater than the first end portion width;
the middle portion width being at least 2.4 inches and at most 3.6 inches;
the flat elastomer strip having a durometer, the durometer being at least 36;
the flat elastomer strip thickness being at least one-sixteenth inch and being at most one-eighth inch;
the flat elastomer strip being capable of withstanding temperatures at least as high as two-hundred twelve degrees Fahrenheit (212 F);
the flat elastomer strip being capable of withstanding temperatures at least as cold as negative twenty degrees Fahrenheit (−20 F) without becoming brittle or breaking;
the first handle-adaptive through-hole perimeter having a rest opening measurement when the first handle-adaptive through-hole is not at stretch,
said rest opening measurement being one of:
a diameter of the first handle-adaptive through-hole perimeter;
an edge length of the first handle-adaptive through-hole perimeter; or,
a diagonal length of the first handle-adaptive through-hole perimeter;
said rest opening measurement being at least one inch (1 in) and at most one and one-half inch (1.5 in);
the flat elastomer strip having a tensile strength of at least 560 pounds per square inch (560 psi);
the latch-enveloping middle portion having sufficient shear strength, sufficient puncture resistance and sufficient deformation resistance to prevent a fifteen pound spring latch from engaging a door jamb so as to lock a door;
the first handle-adaptive end portion having a shape characterizable as one of:
a rectangle end having square corners, an end edge and two side edges; or,
a rectangle end having rounded corners, an end edge and two side edges; or,
an ovular end having two rounded side edges; or, a lozenge end having a rounded tip and two side edges;
and, the first handle-adaptive through-hole having a continuous edge, the first handle-adaptive hole being equidistant the two side edges of the first handle-adaptive end portion.

19. A method of arresting a lockable door in an unlocked state, comprising the steps of:
travelling to a first building having a first lockable door;
removing a disposable emergency duty latch arresting strip from a clothing pocket, belt pouch or dispenser, the disposable emergency duty latch arresting strip comprising:
a flat elastomer strip having a rest length, a stretch length, a rest width and a thickness,
said rest length being greater than said rest width and said width being greater than said thickness,
said stretch length being the greatest length to which the flat elastomer strip can be stretched lengthwise before breaking,
said flat elastomer strip having a lengthwise elasticity, said lengthwise elasticity being defined as the ratio of the flat elastomer strip's stretch length to its rest length at room temperature,
said flat elastomer strip comprising:
a first handle-adaptive end portion being an end of the flat elastomer strip,
a second handle-adaptive end portion being an end of the flat elastomer strip opposite the first handle-adaptive end portion,
a latch-enveloping middle portion disposed between the first handle-adaptive end portion and second handle-adaptive end portion,
said first handle-adaptive end portion having a first handle-adaptive through-hole with a perimeter;
said second handle-adaptive end portion having a second handle-adaptive through-hole with a perimeter;
said latch-enveloping middle portion having sufficient shear strength, sufficient puncture resistance and sufficient deformation resistance to arrest a standard door-latching spring-bolt;
unfolding or unrolling said disposable emergency duty latch arresting strip;
fitting the first handle-adaptive through-hole around a first door knob, handle or lever of said first door disposed on a first surface of said first door;
wrapping the flat elastomer strip around a first door-edge of said first door adjacent said first door knob, handle or lever
covering a latch-bolt or dead-bolt of said first door using the latch-enveloping middle portion of the flat elastomer strip;
fitting the second handle-adaptive through-hole around a second door knob, handle or lever of said first door disposed on a second surface of said first door opposite said first surface;
entering the first building via said first door;
returning to said first door;
removing the disposable emergency duty latch arresting strip from the first door;
folding or rolling said disposable emergency duty latch arresting strip into a compact shape;
returning the disposable emergency duty latch arresting strip to a clothing pocket, belt pouch or dispenser;
travelling to a second building having a second lockable door;
removing the disposable emergency duty latch arresting strip from a clothing pocket, belt pouch or dispenser, unfolding or unrolling said disposable emergency duty latch arresting strip a second time;
tying the flat elastomer strip around a third door-pull, U-bar or push-bar of said second door disposed on a third surface of said second door
by wrapping said first handle-adaptive end portion around said third door-pull, U-bar or push-bar and
threading the second handle-adaptive end portion through the first handle-adaptive through-hole;
wrapping the flat elastomer strip around a second door-edge of said second door adjacent said third door-pull, U-bar or push-bar by
pulling the second handle-adaptive end portion around said second door-edge;
covering a latch-bolt or dead-bolt of said second door using the latch-enveloping middle portion of the flat elastomer strip;
fitting or tying the second handle-adaptive through-hole to a fourth door knob, handle, lever, door-pull, U-bar or push-bar of the second door disposed on a fourth surface of said second door; and,
entering the second building via said second door.

20. A disposable emergency duty latch arresting strip prepared by a process comprising the steps:
selecting a sheet of elastic material,
the elastic material having an elasticity of at least 240%;
the elastic material being capable of withstanding temperatures at least as high as two-hundred twelve degrees Fahrenheit (212 F);
the elastic material being capable of withstanding temperatures at least as cold as negative twenty degrees Fahrenheit (−20 F) without becoming brittle or breaking;
the elastic material having a tensile strength of at least 560 pounds per square inch (560 psi);
the elastic material having a Shore (A) hardness between 36 and 54;
the sheet of elastic material having a thickness at least one-sixteenth inch ( 1/16^{th} in.) and at most one-eighth inch (⅛ in.);
placing the sheet of elastic material on a cutting surface;
cutting a flat elastomer strip from the sheet of elastic material, the flat elastomer strip having a rest length of at least 8 inches and at most 12 inches;
the flat elastomer strip having a shape characterizable as one of:
a rectangle;
a lozenge;
a rectangle with rounded corners; or,
an elongated oval;
the flat elastomer strip comprising:
a first handle-adaptive end portion having a first end portion width;
a second handle-adaptive end portion having a second end portion width;
a latch-enveloping middle portion having a middle portion width,
the middle portion width being equal to or greater than the first end portion width;
the middle portion width being at least 2.4 inches and at most 3.6 inches;
the first handle-adaptive end portion having a shape characterizable as one of:
a rectangle end having square corners, an end edge and two side edges; or,
a rectangle end having rounded corners, an end edge and two side edges; or,
an ovular end having two rounded side edges; or,
a lozenge end having a rounded tip and two side edges;
the second handle-adaptive end portion having a shape characterizable as one of:
a rectangle end having square corners, an end edge and two side edges; or,
a rectangle end having rounded corners, an end edge and two side edges; or,
an ovular end having two rounded side edges; or,
a lozenge end having a rounded tip and two side edges;
the process further comprising the step of:
cutting a first handle-adaptive through-hole into the first handle-adaptive end portion, the first handle-adaptive through-hole having a continuous perimeter,
the first handle-adaptive through-hole continuous perimeter having a first rest opening measurement when the first handle-adaptive through-hole is not at stretch,
said first rest opening measurement being one of:
a diameter of the first handle-adaptive through-hole perimeter;
an edge length of the first handle-adaptive through-hole perimeter; or,
a diagonal length of the first handle-adaptive through-hole perimeter;
said first rest opening measurement being at least one inch (1 in) and at most one and one-half inch (1.5 in);
the first handle-adaptive through-hole being equidistant the two side edges of the first handle-adaptive end portion;
the process further comprising the step of:
cutting a second handle-adaptive through-hole into the second handle-adaptive end portion, the second handle-adaptive through-hole having a continuous perimeter,
the second handle-adaptive through-hole continuous perimeter having a second rest opening measurement when the second handle-adaptive through-hole is not at stretch,
said second rest opening measurement being one of:
a diameter of the second handle-adaptive through-hole perimeter;
an edge length of the second handle-adaptive through-hole perimeter; or,
a diagonal length of the second handle-adaptive through-hole perimeter;
said second rest opening measurement being at least one inch (1 in) and at most one and one-half inch (1.5 in);
the second handle-adaptive through-hole being equidistant the two side edges of the second handle-adaptive end portion;
the process further comprising the step of:
removing the flat elastomer strip from the cutting surface.
